(19) United States
(12) Patent Application Publication
(10) Pub. No.: US 2017/0197186 A1
(43) Pub. Date: Jul. 13, 2017

(54) METHOD AND DEVICE FOR OXYGENATING DRINKING WATER

(71) Applicants: Sudhir R. Brahmbhatt, Glencoe, MO (US); Richard Masi, Middletown, DE (US)

(72) Inventors: Sudhir R. Brahmbhatt, Glencoe, MO (US); Richard Masi, Middletown, DE (US)

(21) Appl. No.: 15/471,978

(22) Filed: Mar. 28, 2017

Related U.S. Application Data
(63) Continuation-in-part of application No. 14/685,016, filed on Apr. 13, 2015.

(51) Int. Cl. B01F 3/04; B01F 15/02; A23L 2/54; C02F 1/68; C02F 1/00

(52) U.S. Cl. CPC B01F 3/04794; C02F 1/685; C02F 1/008; A23L 2/54; B01F 15/026; C02F 2103/02

(57) ABSTRACT

A method and device (10) for producing and dispensing oxygenated water. A mixing unit (30) has an inlet for supplying water to the mixing unit, and an inlet for supplying oxygen to the unit. Separate control valves or devices are installed in the respective flow paths by which water and oxygen are directed to their respective inlets so to separately control the rate at which water and oxygen are supplied to it. The mixing unit includes an element (39) for dissolving oxygen supplied to the mixing unit into the water also supplied thereto, the mixing unit controlling the level of oxygen dissolution into the water. A dispenser (46) is connected to an outlet (42) of the mixing unit for dispensing oxygenated water into a container (G) for subsequent consumption. It is desirable to consume the oxygenated water as soon as possible to realize the full benefits of the oxygen dissolved in water.

### CROSS-REFERENCE TO RELATED APPLICATION

This is a continuation-in-part of U.S. patent application Ser. No. 14/685,016, filed Apr. 13, 2015.

### BACKGROUND OF THE INVENTION

This invention relates to drinking water for consumption by humans and/or other living organisms; and, more particularly, to a device and method for oxygenating drinking water which maximizes the dissolution of oxygen in the water.

It is known in the art to introduce pressurized or non-pressured oxygen into a water filled bottle for sale as oxygenated water. However, it has been found that where a container of oxygenated water is not fairly quickly sold or is otherwise stored for a period of time; the oxygen migrates into the overhead space of the bottle, or permeates out through the bottle media. In such instances, the oxygen content in the water is lost.

A significant amount of prior work has been done which demonstrates the benefits of consuming oxygenated water in the human body and other living beings. But, while oxygenated water is highly desirable for human and other living beings consumption for both health and fitness reasons, there has heretofore been no practical solution to overcome the storage problem associated with it.

The present invention now allows consumers to produce oxygenated water for immediate consumption. As described hereinafter, the invention facilitates production of oxygenated water from pressurized potable water and makes it available for immediate consumption.

### BRIEF SUMMARY OF THE INVENTION

In accordance with the present disclosure, to ensure an equilibrium dissolution of oxygen in potable water, a device has been developed that maximizes the dissolution of oxygen in the water, and delivers the resulting product to an end user for immediate consumption. The device and the method employed take advantage of time, temperature, and pressure factors to maximize the delivery and efficiency of oxygenation to accomplish this goal.

To ensure that oxygen stays in water while drinking water is consumed, the time between oxygenation and consumption is minimized to the greatest extent possible, as are the gas and water pressures, and the time required for injection of the oxygen into the water. In addition, the temperature range of both media is also optimized to prevent degassing. The method of the invention optimizes the efficient use of oxygen. Colder water will increase the dissolved oxygen holding capacity of water and is desirable; but, there is no guarantee of maintaining the oxygen level in the oxygenated water unless it is held at temperature prior to its timely consumption.

The invention also includes a home-based appliance for supplying oxygenated water to a consumer, for immediate consumption, and a method of using such appliance. The user inserts a cup or other open container into a suitable receptacle formed in the appliance. The appliance includes the necessary valves, the settings of which are determined by control inputs made by the user, to allow oxygen to flow, from a tank or cylinder, into a tank or conduit containing tap water, so that the oxygen mixes with the tap water before it is dispensed into the cup. An indicator can be provided on a panel, on the housing of the appliance, to show the level of dissolved oxygen in the water. The user may adjust the level of dissolved oxygen by adjusting the flow rate of the oxygen. The user then drinks the oxygenated water, after it has been dispensed.

Other objects and features will be in part apparent and in part pointed out hereinafter.

### BRIEF DESCRIPTION OF THE SEVERAL VIEWS OF THE DRAWINGS

The accompanying figures, together with detailed description which follows, form part of the specification and illustrate the various embodiments described in the specification.

FIG. 1 is a perspective view of a device dispensing oxygenated water;

FIG. 2 is a block/flow diagram of the components housed in the device;

FIG. 3 is a block diagram for a potable oxygen enriched water unit; and,

FIG. 4 is a simplified block diagram of an automated system for dynamically controlling the ratio of water to oxygen.

Corresponding reference characters indicate corresponding parts throughout the several views of the drawings.

### DETAILED DESCRIPTION OF THE INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

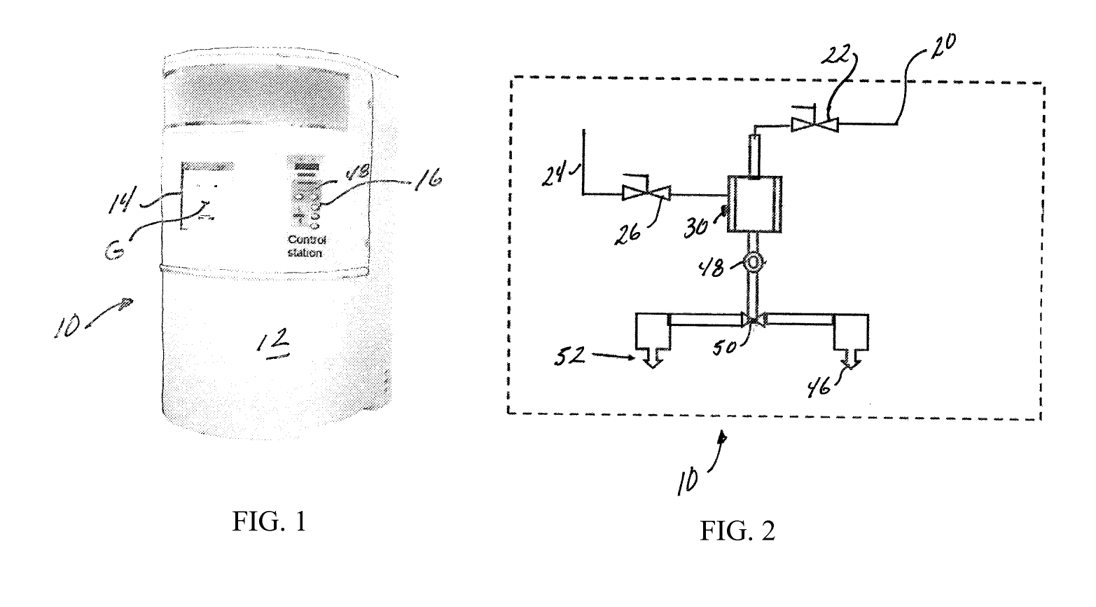

Referring to the drawings, a device for dispensing oxygenated water to a consumer is indicated generally 10 in FIG. 1. Device 10 includes a housing 12 in which components of the device are installed. A recess 14 is formed in the housing for placement of a glass G or other container into which oxygenated water is dispensed. A control station or panel 16 is installed on the housing and includes controls for monitoring and controlling the water oxygenation process.

Device 10 is connected to a water line 20 by which water is drawn into the device through a control valve 22. An oxygen supply line 24 is connected to a source of oxygen for oxygen to be supplied to device 10 through a flow control valve 26. Both the water and oxygen are directed to inlets of a unit 30. Unit 30 mixes the water and oxygen to produce the oxygenated water which is dispensed from an outlet 46 into container G. Flow of oxygenated water from unit 30 is monitored, for example, using a visual indicator 48.

Oxygenated water from unit 30 is directed through a T-connection 50 to dispensing outlet 46 with any excess flow from unit 30 being directed to a drain 52.

The water and oxygen now flowing into device 10 are respectively supplied to inlets 34 and 36 of a mixing unit 38. Mixing unit 38 can be one of a number of mixing elements, including, for example, a diffuser, or a membrane unit with or without a static mixer. The mixing unit includes a mixing element 39 for mixing the water and oxygen supplied to the mixing unit 38. If a membrane or similar high diffusion device is used, a static mixer may or may not be needed as membrane dissolution efficiencies can be well over 98% based on information from the manufacturer of the membrane. In the case of a diffuser, a static mixer will further enhance the intimate mixing of oxygen with water so to optimize dissolution of oxygen in the water. In addition, a pre-filter and membrane unit in the device is a replaceable item to ensure the efficient transfer of oxygen into the water. The time for replacement of these consumable items can be established based on the quality of the membrane unit chosen for the system and the quality of the water source.

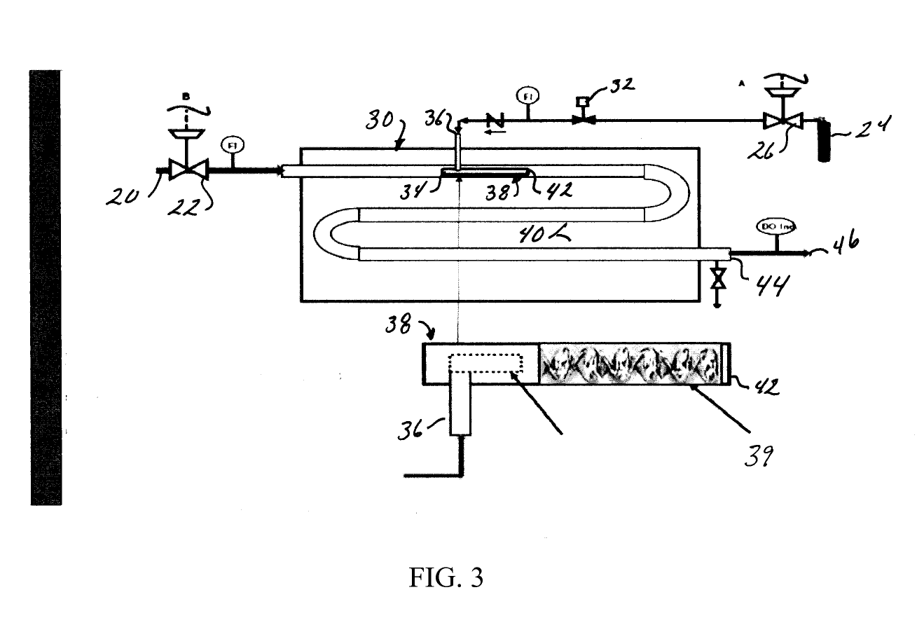

As further shown in FIG. 3, the mixing unit can be connected in a serpentine piping arrangement or system, indicated generally at 40, of unit 30. Other methods to increase the contact time at a given temperature and pressure are available and known to those skilled in the art; it being understood that the overall goal is to maximize the contact time between the water and oxygen. An outlet 42 of unit 38 is connected to an inlet of piping system 40. The oxygen enriched tap water produced by unit 30 flows from an outlet 44 of piping system 40 to the outlet 46 which is located in the top of recess 14 for dispensing into container G. A visual indicator 48 in the supply line from unit 30 is ideally installed in a control panel 16 to view the oxygenated water as it is dispensed. Although this is a beneficial feature, it is not required to obtain the desired results.

Oxygenated drinking water produced by unit 30 can also be directed to a refrigerator (not shown) for dispensing from a drinking water outlet of the refrigerator. In another embodiment the refrigerated and/or illuminated dispenser is integral to the system.

Other features of the device as described above are that, ideally, the water source is preferably cold as it has been demonstrated that a lower temperature maximizes the retention of dissolved oxygen. Next, a pressurized gaseous oxygen source (typically a cylinder or oxygen generating device or an alternative supply of high concentration oxygen) is connected to the oxygen line so to provide highly enriched (essentially pure oxygen) to unit 30 used to dissolve oxygen in the drinking water. Finally, the water and oxygen are delivered within a desired range of pressures and temperatures to maximize the efficiency of the process and maximize the dissolved oxygen content of the water.

Operation of device 10 is such that when oxygenated water is desired to be produced, one takes the following steps in generally and ideally the order described below.

1) Insert a clean drinking cup or other dispenser G like a mug or bottle into recess 14 of the device.

2) Turn on the connected pressurized (preferably chilled) potable water supply, and confirm the bypass is discharging into an appropriate drain (e.g., a sink).

3) Turn on the regulated oxygen supply source and observe the flow of fine bubbles through visual indicator 48, if installed. Reference can be made to a reference chart of proper bubble patterns and correlated injected efficiency.

4) Alternatively, or in addition, a Dissolved Oxygen (D.O.) reading can be read from the bypass stream, once it reaches a 20 ppm-45 ppm range, or more or less depending on the temperature and pressure of water and oxygen, or the bubble swarm is correct.

5) Turn valve 46 to DISPENSE and direct oxygenated water to the container G.

6) Upon dispensing a sufficient quantity of oxygenated water, return turn valve 46 to the off position.

7) Then, close oxygen supply valve 26 so to purge standing water from the device.

8) Next, shut off water supply valve 22 and drain the line through drain 52.

When oxygenated water is desired, perform the following steps:

1) Connect the pressurized potable water line 20 to device 10 and turn on the water.

2) Open oxygen valve 26 and observe the oxygen pressure. If equipped with a flowmeter observe that the flow is at a desired rate. The oxygen flow corresponds to a certain water flow rate. A flow indicator on panel 16 will aid in ensuring proper flow.

3) Alternatively, or in addition, a Dissolved Oxygen (D.O.) reading can be made on panel 16 to read the oxygenated water level. Once the level reaches 20 ppm-45 ppm, depending on temperature and pressure of water and oxygen, the oxygenated water can be dispensed and consumed. It is important that any oxygen gas from the oxygenated water is degassed by agitating the container G into which the water is dispensed.

4) Upon having sufficient quantity of oxygenated water, oxygen valve 26 can be turned off. Once oxygen flow is zero and then turn off water flow control valve 22.

5) Then make sure that the water is drained from the unit.

6) As a safety measure and/or convenience, a solenoid valve 32 (see FIG. 2) is used to ensure that oxygen line is off when there is no water flow in the pipe.

In other embodiments of the invention, device 10 can be modified such that oxygen flow is set in accordance with the water flow rate and this can be accomplished automatically using pneumatic, mechanical, or electrical controls. Again, this is done to optimize the ratio of water and oxygen in the dispensed oxygenated water.

In the above regard, oxygen flow rate is automated (i.e., controlled) based on water flow as a function of the amount of water used. Once the water flow rate is sensed, an optimum oxygen flow rate is determined and the oxygen flow controlled to that rate.

Another feature is to allow a user to automatically inject oxygen into the water, again using pneumatic, mechanical, or electrical controls. This feature enables one to oxygenate the water to a desired level for their own particular needs.

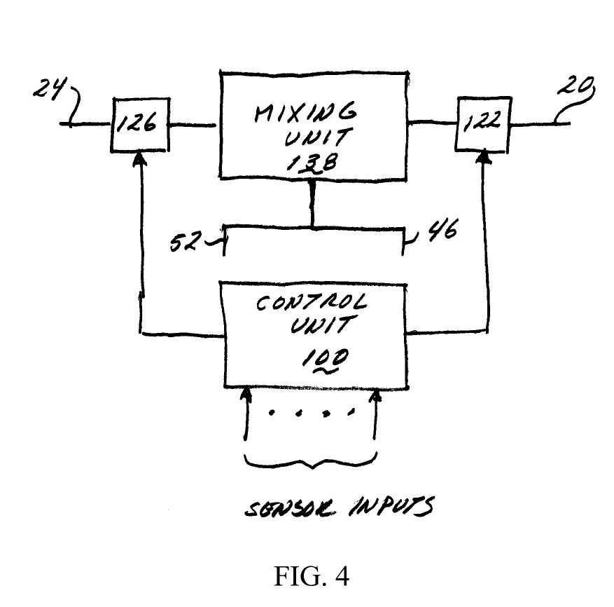

Also, in another embodiment of the invention, a ratio control system (including valves, electronically operated valve controllers, a particular energy source (battery, solar, etc.), and other components is implemented so vary the ratio between water and oxygen so to dynamically adjust the ratio as a function of various inputs to the system. This is as shown in FIG. 4.

As shown in FIG. 4, a control unit 100 receives inputs from sensors (not shown) and processes this information. The control unit, using the results of this processing, then accesses schedules stored within the control unit to determine what the water-to-oxygen ratio should be for a sensed set of operating conditions. The control unit then uses this information to electronically control both a water flow control valve 122 and an oxygen flow control valve 126. The result is that the amounts of water and oxygen flowing to a mixing unit 138 will produce oxygenated water of the desired water-to-oxygen ratio.

The device of the present invention, described above, can be provided in the form of a home-based appliance which dispenses oxygenated water to a consumer. The present invention includes such appliance, and the method of using it.

In using the appliance of the present invention, the consumer performs the following steps.

1) Once the device has been set up, the oxygen valve 26 is open and the water valve 22 is open. The control station 16 can be used to operate the device 10.

2) The user observes the oxygen pressure, and the oxygen flow, from indicators provided at the control station 16, and can determine that the oxygen flow is as desired. In general, the desired oxygen flow will correspond to a certain desired water flow rate.

3) Alternatively, or in addition, a dissolved oxygen (DO) value for the oxygenated water can be read from an indicator on control station 16. If necessary, the oxygen flow rate can be adjusted, to insure that the dissolved oxygen level falls between about 20 ppm to 45 ppm, depending on the temperature and pressure of the water. When the dissolved oxygen level reaches the desired value, the oxygenated water can be dispensed and consumed.

4) It is important that any excess oxygen gas in the oxygenated water be removed. The water can be degassed simply by agitating the cup or other container into which the water has been dispensed. Excess gas means a quantity of gas which exceeds the amount which can be dissolved in the water in the container, under current conditions of temperature and pressure.

5) When the consumer has had enough oxygenated water, the oxygen flow and water flow can be turned off by controls on panel 16.

6) To insure that the water line remains clean, it is good practice to open the drain line and remove it from the device 10. If the device is not intended to be used for an extended period of time, the solenoid valve 32 can be turned off when there is no water flow.

The opening and closing of valves is preferably performed automatically, in response to a control input from the user. For example, the user may simply push a button which activates the process of mixing oxygen with the tap water, and delivering the oxygenated water to the cup positioned in a recess in the housing of the appliance. The appliance can be designed to open and close the necessary valves automatically, without the specific intervention of the user.

The home-based appliance of the present invention is intended to be connected to a source of ordinary tap water. Tap water is normally delivered at a pressure of about 20-30 psig. The pressure of the oxygen introduced into the tap water should be about 40-50 psig. This pressure is greater than the water pressure because it is necessary to overcome the pressure drop due to the piping size and the diffuser.

The oxygenated water will stay oxygenated for a period of time, because the oxygen is not dissolved under substantial pressure. As long as the user does not shake the container, the water could be consumed within the next 15-20 minutes. This is similar to what is experienced with carbonated water when it is dispensed from a machine. Exposure to air will gradually force oxygen to come out to achieve a new equilibrium. As used in this specification, the term “immediate consumption” therefore means that the water is consumed as soon as it is dispensed, or up to about 15-20 minutes thereafter.

It is important to note that, in the home-based appliance described above, there is no recycling of oxygen. Oxygen is delivered at a relatively low pressure, as explained above, and is delivered in a quantity intended to achieve a desired dissolved oxygen content, and no more. Thus, in general, there will not be a substantial amount of wasted oxygen. To the extent that some excess oxygen is introduced into the cup or container, it is removed by shaking the container. That is, the excess oxygen exits the water, and escapes into the surrounding atmosphere. In no case is the excess oxygen returned or recycled.

In view of the above, it will be seen that the several objects and advantages of the present disclosure have been achieved and other advantageous results have been obtained.

What is claimed is:

1. A method of producing oxygenated water for immediate consumption, comprising:
a) providing an appliance defining a recess for receiving a cup, the appliance including means for storing and supplying oxygen to water in a water line, and including means for connecting the water line to a source of tap water,
b) placing the cup in the recess,
c) opening at least one valve to enable oxygen from the storing means to become mixed with tap water from said source, and to enable oxygenated water to be dispensed into the cup,
d) closing the valve when sufficient oxygenated water has been dispensed, and
e) consuming the oxygenated water immediately after it is dispensed.

2. The method of claim 1, wherein the method further comprises storing oxygen at a pressure of about 40-50 psig.

3. The method of claim 1, wherein the method comprises delivering sufficient oxygen such that a level of dissolved oxygen in the water is in a range of about 20-45 ppm.

4. The method of claim 1, further comprising venting any excess oxygen to a surrounding environment.

5. The method of claim 1, wherein the appliance includes means for adjusting a flow rate of the oxygen, and wherein the method comprises the step of adjusting the flow rate until a level of dissolved oxygen in the water is in a range of about 20-45 ppm.

6. The method of claim 1, further comprising cooling the tap water before it is mixed with the oxygen.

7. The method of claim 1, further comprising agitating the cup so as to remove substantially all excess oxygen from the oxygenated water, and wherein excess oxygen released by the agitating step is not recycled or re-used.

8. A method of producing oxygenated water for immediate consumption, comprising:
a) delivering oxygen at a pressure of about 40-50 psig,
b) directing said oxygen to mix with a quantity of tap water to produce oxygenated water, the directing step being performed while controlling a flow rate of the oxygen such that the oxygenated water has a dissolved oxygen level of about 20-45 ppm,
c) dispensing the oxygenated water into an open drinking container, and
d) consuming the oxygenated water immediately thereafter.

9. The method of claim 8, further comprising controlling a flow rate of said tap water, such that the tap water and the oxygen become mixed in a desired ratio.

10. The method of claim 8, wherein the controlling step includes monitoring an indicator of bubble size to determine the level of dissolved oxygen.

11. The method of claim 10, further comprising cooling the tap water before it is mixed with the oxygen.

12. The method of claim 8, further comprising agitating the drinking container so as to cause excess oxygen in the oxygenated water to escape into a surrounding atmosphere.

13. The method of claim 12, wherein substantially all excess oxygen is removed by the agitating step, and wherein excess oxygen is not recycled or re-used.
